(19) United States
(12) Patent Application Publication
(10) Pub. No.: US 2013/0066820 A1
(43) Pub. Date: Mar. 14, 2013

(54) SYSTEM AND METHOD FOR EVIDENCE-BASED DECISION BOOTSTRAPPING

(71) Applicants: Atul Apte, North Las Vegas, NV (US); Ashok Chennuru, Powell, OH (US); Sean J. Hickman, Glastonbury, CT (US); Rickey Tang, Southwick, MA (US)

(72) Inventors: Atul Apte, North Las Vegas, NV (US); Ashok Chennuru, Powell, OH (US); Sean J. Hickman, Glastonbury, CT (US); Rickey Tang, Southwick, MA (US)

(73) Assignee: WELLPOINT, INC., Chicago, IL (US)

(21) Appl. No.: 13/606,650

(22) Filed: Sep. 7, 2012

Related U.S. Application Data
(60) Provisional application No. 61/532,314, filed on Sep. 8, 2011.

(51) Int. Cl. G06N 5/02

(52) U.S. Cl. 706/46

(57) ABSTRACT

The systems and methods relate to decision making processes. Data associated with a request for a decision is received. Risks associated with the request are identified. Decision queries associated with each of the identified risks are determined. Any non-standard attributes associated with each of the identified risks are identified. A confidence level threshold for each of the identified risks is determined. A decision recommendation, generated by a machine learning component, is received. The decision recommendation includes a response to each of the one or more decision queries, determined based on the exceptional attributes, if any, and a confidence level associated with the response. The confidence level is compared to the confidence level threshold. Based on the comparison, a decision path for responding to the request is determined. Decision path actions are determined based on the decision path.

### CROSS REFERENCE TO RELATED APPLICATIONS

This application claims priority to U.S. Provisional Patent Application No. 61/532,314, filed Sep. 8, 2011, the entirety of which is incorporated herein by reference.

### FIELD OF THE INVENTION

The systems and methods described herein relate to efficient and consistent decision-making processes.

### SUMMARY OF EMBODIMENTS OF THE INVENTION

The present invention is directed to systems, methods and computer-readable media for use in connection with decision making processes. Data associated with a request for a decision is received. Risks associated with the request are identified. Decision queries associated with each of the identified risks are determined. Any non-standard attributes associated with each of the identified risks are identified. A confidence level threshold for each of the identified risks is determined. The confidence level threshold is a ratio of a risk level associated with each of the identified risks and a minimum confidence level for any recommendation to mitigate each of the identified risks. A decision recommendation, generated by a machine learning component, is received. The decision recommendation includes a response to each of the one or more decision queries, determined based on the exceptional attributes, if any, and a confidence level associated with the response. The confidence level is compared to the confidence level threshold. Based on the comparison, a decision path for responding to the request is determined. Decision path actions are determined based on the decision path.

### BRIEF DESCRIPTION OF THE DRAWINGS

FIG. 1 is a flow diagram illustrating an exemplary decision making process;

FIG. 2 is a block diagram illustrating exemplary components of and relationships among the components of a bootstrapping decision path pattern;

FIG. 3 is a block diagram illustrating exemplary components of and relationships among the components of a contextual synthesis of request pattern;

FIG. 4 is a block diagram illustrating exemplary components of and relationships among the components of the evidence based decision bootstrapping solution;

FIG. 5 is a block diagram illustrating exemplary components of the synthesis assessment algorithm; the confidence level assessment algorithm; and the decision path bootstrapping algorithm;

FIG. 6 is a diagram illustrating an exemplary system for carrying out an exemplary embodiment of the present invention;

FIGS. 7A and 7B are a flow diagram illustrating an exemplary method for carrying out an embodiment of the present invention; and

FIG. 8 is a system diagram illustrating exemplary computer hardware and software components that may be used in connection with an embodiment of the present invention.

### DETAILED DESCRIPTION

Healthcare decisions are generally complex and based on multiple variables. The probability of different interpretations in medical diagnosis, recommended procedures, and long term treatment regimens add further complexity to the decision making process. The highly regulated healthcare industry and the unique circumstances of delivering healthcare services to a diverse population of patients extend the complexity to all stakeholders involved in the healthcare system. Healthcare payers and healthcare organizations are constantly working to improve the efficiency of core decision making processes through innovations.

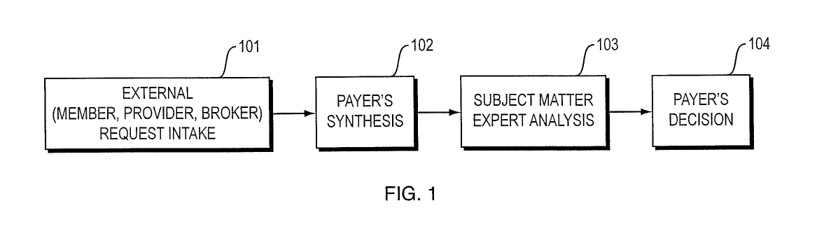

FIG. 1 illustrates a commonly practiced, external stakeholder decision making process in the healthcare payer industry, composed of four sets of activities/workflows. An exemplary scenario of this decision making process is described as follows. A stakeholder/healthcare care provider (physician or physician's office) submits a request, in step 101, to a healthcare payer, asking for approval or authorization for a medical procedure to be performed on a patient who has a healthcare policy with the healthcare payer. The healthcare payer's utilization management team reviews the request and conducts an eligibility check of the submitted request, in step 102. Experts (e.g., registered nurses (RNs), medical directors (MDs) or other highly skilled knowledge workers) in the healthcare payer's office conduct a detailed analysis of the request, in step 103. This analysis may include applying relevant healthcare policies and guidelines, introspection of any applicable history of prior medical procedures, and the general applicability of the requested medical procedure relative to the unique circumstances of the associated patient. The healthcare payer renders a decision on the submitted request, in step 104. This decision could be an approval (full approval or partial approval) of the submitted request, or a denial (full denial or partial denial) of the submitted request, or issuing a request for further information if an approval or denial decision cannot be rendered.

The systems and methods described herein involve decisioning capabilities to identify optimal next actions. In some embodiments, this takes place in a real-time process, such as during a telephonic customer service interaction or an inquiry submitted via a web site. The technology for enabling evidence-based decision bootstrapping described herein is derived from a motivation to realize an increase in efficiency of knowledge worker-related workflows. The ongoing shortfall in knowledge workers, coupled with the radically changing healthcare industry, has created urgency for innovation-driven optimization of administrative processes and workflows.

Two patterns emerge in connection with the decision making processes described herein: a bootstrapping decision path pattern and a contextual synthesis of request pattern.

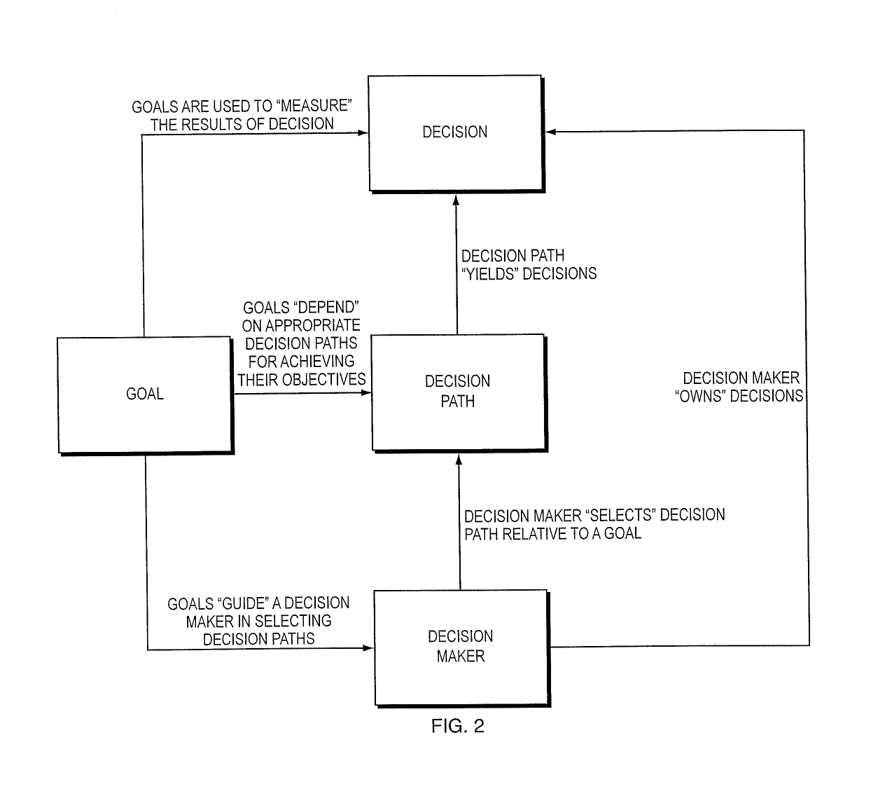

FIG. 2 illustrates the exemplary components of and relationships among the components of the bootstrapping decision path pattern. Decision-making processes are, fundamentally, based on one or more decision paths that are selected and used by decision makers to arrive at specific decisions. Each decision path is a self-contained set of pre-defined concrete actions that yield a specific type of decision. The decision making pattern enables pre-determination of decision paths based on specific goals. There are several benefits of this pattern. The bootstrapping of a decision path for decision makers (e.g., knowledge workers) significantly reduces the administrative activities involved in the decision-making processes. The technological solution described herein involves explicit selection of the decision path and its association to goals. The bootstrapping decision path pattern creates an optimum process for making quality decisions and supports decision makers at any level of knowledge or expertise. Other decision engine technologies focus on capturing decision matrices as business rules or provide collaboration software to help decision makers maintain control of the decision making process. The decision making pattern described herein extends these concepts and enables pre-determination of a specific decision path (e.g., Approval, Denial, Request for Information) based on the decision maker's goals and roles and responsibilities.

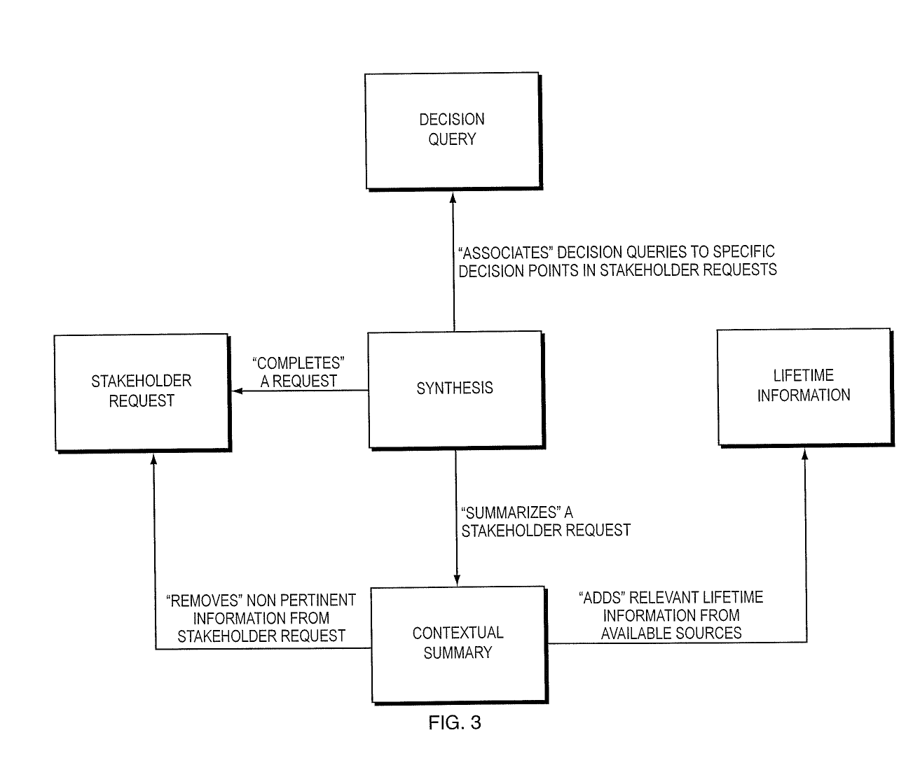

The contextual synthesis of request pattern is now described. FIG. 3 illustrates the primary components and relationships of the contextual synthesis of request pattern, which involves a contextual analysis of stakeholder requests. Contextual analysis is part of a synthesis process designed to verify or validate a stakeholder request. The contextual synthesis pattern includes at least two concepts that significantly enrich the synthesis process. The concept of associating decision queries to each decision point necessary to fulfill a stakeholder request ensures that the final decision is of high quality as well as consistent. A decision query is a mechanism for requesting a decision recommendation, which provides an added data point for elevating or improving instinctive decisions. The addition of relevant information (e.g., in the healthcare context, historical information from all available internal and external information sources for a patient) enriches the decision query resulting in high confidence level decision recommendations. Employing the contextual synthesis request pattern, decision makers (such as knowledge workers) benefit from high quality decision recommendations and render high quality decisions on significantly shorter timelines.

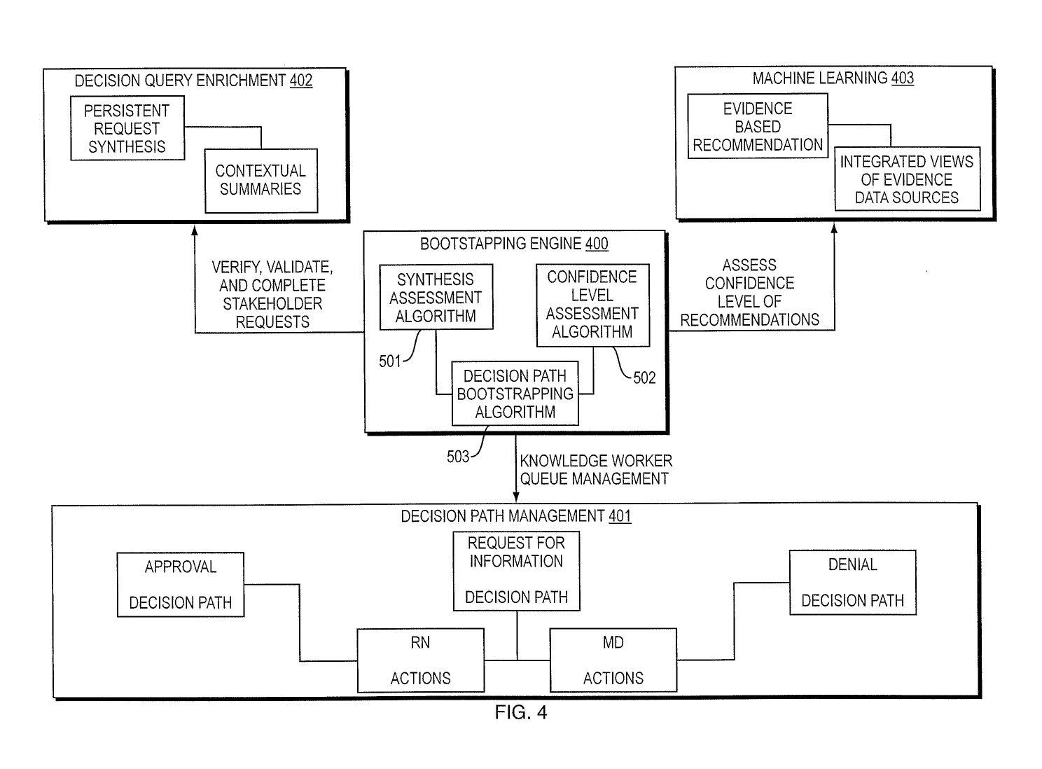

The evidence-based decision bootstrapping solution is a forward-looking implementation of these two technology design patterns—i.e., the bootstrapping decision path pattern and contextual synthesis of request pattern. The solution integrates high efficiency decision making processes for knowledge workers across all healthcare domains, in the exemplary embodiment. FIG. 4 illustrates the integrated components of the evidence based decision bootstrapping solution. The evidence based decision bootstrapping solution includes the following capabilities, in the preferred embodiment, and described in more detail below: decision query enrichment engine 402; machine learning engine 403; bootstrapping engine 400; and decision path management engine 401.

The decision bootstrapping solution employs algorithms for validating request synthesis captured in contextual summaries, enriching decision queries, and assigning confidence levels of decision recommendations generated by machine learning components. Machine learning has been successfully used in pattern recognition through implementation of neural networks and back propagation algorithms. Bootstrapping decision paths extends the use of machine learning and pattern recognition for automatically selecting appropriate decision paths based on confidence levels of achieving a specific decision goal. The integration of the decision bootstrapping engine with machine learning moves decision makers away from instinctive decision paths and towards adopting an evidence-based decision path for making critical healthcare decisions. Evidence-based decision paths examine historical decisions and consistently apply multiple evidence data sources before determining the confidence level of a decision recommendation.

The decision query enrichment component 402 transforms received queries into decision queries that contain a synthesis of the stakeholder request along with a context-based summary of decision points necessary to fulfill the stakeholder request. The decision path management component 402 is also capable persisting request synthesis as future training data for machine learning component 403.

The decision path management component 401 creates specific instances of decision path workflows and associated specific decision maker actions depending on the decision maker's role and responsibility. The decision path management 401 component pre-determines the set of decision maker actions on a case-by-case basis, depending on the contextual summaries in the enriched queries.

The systems and methods described herein involve integration of the bootstrapping engine 400 with query enrichment 402, machine learning 403, and decision path management 401 components. The bootstrapping engine 400 executes specific algorithms associated with each core component with the intent of assigning each stakeholder request to a single decision path. This results in a highly efficient decision making process where knowledge workers can focus on applying a consistent set of actions specific to each decision path.

Most stakeholder requests related to healthcare services have to be processed on a case-by-case basis. This is necessary to provide personalized care and maintain objectivity of healthcare decisions. Even if the final decision rendered is consistent with other cases, each case is processed individually. The case-by-case processing model usually results in high administration costs. The bootstrapping decision path technology brings significant efficiency to case-by-case processing models.

Stakeholder requests come in many forms and vary in content, quality, and scope of information attached to a request. Hence, a synthesis of each request by knowledge workers is essential to normalize each request into an actionable query. The bootstrapping decision path technology identifies exceptional attributes in a stakeholder request. These exceptional attributes are analyzed and processed by knowledge workers. The completed request is then transformed into actionable decision queries.

There are a finite number of decision paths in any decision making process. However, consistency of decisions yielded by a decision path depends partially on the decision maker's actions. Decision makers are trained to follow a specific set of actions to process an entire case or a specific stakeholder request within a case. Training alone cannot achieve consistency in decision maker actions, especially in a high volume scenario. Automated bootstrapping of decision maker actions ensures consistency irrespective of case or stakeholder request volumes and the decision maker's knowledge and skills.

For example, RNs need, on average, 15 minutes to analyze a pre-authorization request and select an appropriate utilization management pre-authorization decision path (i.e., approve the pre-authorization request; request more information for pre-authorization request; or deny the pre-authorization request). Additional decision paths are also possible, such as split or modified decisions. For example, a pre-authorization request for 60 sessions of physical therapy may result in an approval of 30 sessions, and a denial of 30 sessions pending evaluation after 30 visits. In addition to the time needed to analyze a pre-authorization request, other complications exist. For example, the selection of the pre-authorization decision path is dependent on the RN's knowledge of medical policies and clinical guidelines. These policies and guidelines often change and, thus, the RN's knowledge needs to be updated. Further, the selection of pre-authorization decision paths is done on a case-by-case basis. Maintaining consistency of pre-authorization decisions across cases is important to quality of care. RNs with several years of experience are needed to consistently process pre-authorization requests. Also, in this particular example, but applicable to other circumstances, the ongoing shortfall in skilled and experienced RNs is can impact the efficiency of pre-authorization request processing workflows. Bootstrapping the pre-authorization decision paths, in accordance with the present invention, enables RNs with varying degree of skills, experience and knowledge of medical policies and clinical guidelines to successfully process pre-authorization requests in an efficient and consistent manner.

The bootstrapping decision path technology is based on design patterns that are applicable to a wide array of decision making and decision management processes across business functions. As such, an implementation of this technology could be an enterprise-wide capability that can be deployed as part of different types of business solutions. The following core principles define an approach for implementation, in one embodiment. Stakeholder request synthesis can be preserved (e.g., persisted or stored) in human understandable and machine reusable formats. Two distinct views of the synthesis may be created, one for human understanding and another for machine learning. Also, service driven access to bootstrapping engine component can be provided. Continuous improvement process may be implemented for enhancing and maintaining the quality of evidence data and machine learning data. The successful outcome of the machine learning component is dependent on high quality data as a source of evidence for decision recommendations. In addition, machine learning mechanisms need high quality historical data for assessing confidence level to decision recommendations. Selection of decision paths and instantiation of decision maker actions can be automated. Consistency of decisions is improved when decision makers follow a set of pre-defined actions to render decisions. A system that automatically selects the next-best action in the chain of actions relative to a decision path ensures process consistency and improves the quality of decisions.

The evidence-based bootstrapping decision technology significantly increases efficiency of decision making processes and the quality of their outcomes through automating the selection of an appropriate decision path based on a particular stakeholder request and addressing foundational aspects, such as including improving the synthesis of stakeholder requests, improving management of decision paths and improving the quality of evidence data required for machine learning. In addition, use of metrics and measurement for tracking improvements may be adopted as part of implementing solutions based on this technology.

The evidence based decision bootstrapping technology is now described with reference to its core components.

The component that captures synthesis of stakeholder requests is based on the contextual synthesis of request pattern described above. The stakeholder request synthesis is captured and preserved in two views, in one exemplary embodiment. One view is created to preserve the synthesis in human understandable format. Another view is created to preserve the synthesis in machine usable format, for reuse by the machine learning and other analytical components. The primary structure of synthesis includes contextual summaries and decision queries. This schema of a stakeholder request synthesis identifies the right context for each stakeholder request and captures the actionable decision queries for knowledge workers.

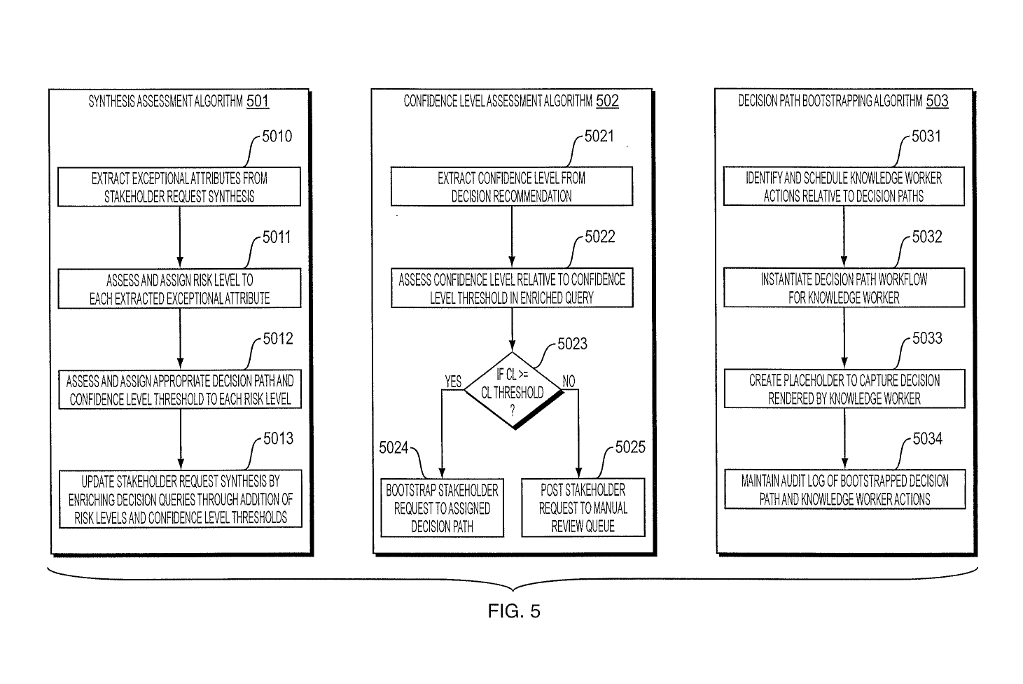

In the preferred embodiment, several algorithms collaborate to integrate stakeholder request synthesis with machine learning and decision path management. FIG. 5 describes the following algorithms: synthesis assessment algorithm 501; confidence level assessment algorithm 502; and decision path bootstrapping algorithm 503.

In connection with the synthesis assessment algorithm 501, exceptional attributes are extracted from the stakeholder request synthesis, in step 5010. Maintaining consistency of healthcare decisions across cases is difficult due to the high number of variables in stakeholder requests. The synthesis assessment algorithm identifies exceptional (i.e., non-standard) attributes of each request. Each exceptional attribute is assigned an assessed risk level, in step 5011. The assignment of appropriate risk level to each exceptional attribute results in more accurate bootstrapping of decision paths.

Confidence level thresholds may be used to bootstrap (i.e., pre-determine) a decision path. The composition of a confidence level threshold, in one embodiment, is a ratio of risk level and confidence level (i.e., the risk level assigned to each exceptional attribute and confidence level of a decision recommendation required to mitigate the assessed risk). The use of confidence level thresholds as instruments of decision path selection is an aspect of this algorithm. In step 5012, the appropriate decision path and confidence level threshold is assessed and assigned to each risk level. In step 5013, the stakeholder request synthesis is updated by enriching the decision queries through addition of risk levels and confidence level thresholds.

The confidence level assessment algorithm 502 is now described. Decision recommendations generated by machine learning components have embedded confidence levels, the confidence levels being determined by the machine learning component. These confidence levels indicate the applicability of available evidence in forming the decision recommendation. Thus, for example, the confidence level will be high with regard to a decision recommendation for which there exists strong, well-documented evidence to support. The confidence level is extracted from the decision recommendation, in step 5021. In step 5022, the confidence level is assessed relative to the confidence level threshold in the enriched query. In step 5023, it is determined whether the confidence level is greater than or equal to the confidence level threshold. If so, in step 5024, the stakeholder request is bootstrapped to the assigned decision path (i.e., the decision path is assigned to be an appropriate decision path responsive to the stakeholder request). If not, in step 5025, the stakeholder request is posted for manual review. Table 1 illustrates an exemplary default table that maps specific ratios to decision paths.

TABLE 1
Mapping risk:confidence level ratios to decision paths

| Decision Path | Risk Averse | Risk Inclined |
|---|---|---|
| Selection Ratio | Decision Path | Decision Path |
| High Risk:High | | X |
| Confidence Level | | |
| High Risk:Low | X | |
| Confidence Level | | |
| Low Risk:High | | X |
| Confidence Level | | |
| Low Risk:Low | X | |
| Confidence Level | | |

An exemplary decision path bootstrapping algorithm 503 is now described. This algorithm involves use of a pre-defined set of knowledge worker actions based on decision goals. The selection of a decision path combined with a pre-defined set of decision path actions results in significantly consistent decisions. Logging bootstrapped decision path and knowledge worker actions is used to support low confidence level scenarios. Generally, decision recommendations that are assessed to have lower confidence levels are assigned to decision paths that are risk averse. Pre-defined knowledge worker actions increase the efficiency and consistency of how low confidence level decision recommendations are mitigated. In step 5031, knowledge worker actions relative to decision paths are identified and scheduled. In step 5032, a decision path workflow is instantiated for the knowledge worker. In step 5033, a placeholder is created to capture a decision rendered by a knowledge worker. In step 5034, an audit log is maintained of bootstrapped decision path and knowledge worker actions.

The integration of these algorithms results in standardizing and bootstrapping of highly efficient decision making processes. The two primary standard decision making processes that are enabled by the bootstrapping engine include the risk adverse decision path selection and the risk inclined decision path selection. The risk adverse decision path is selected for stakeholder requests that may result in higher risks. The risk inclined decision path is selected for stakeholder requests whose associated risks can be managed within an organization's policies and guidelines.

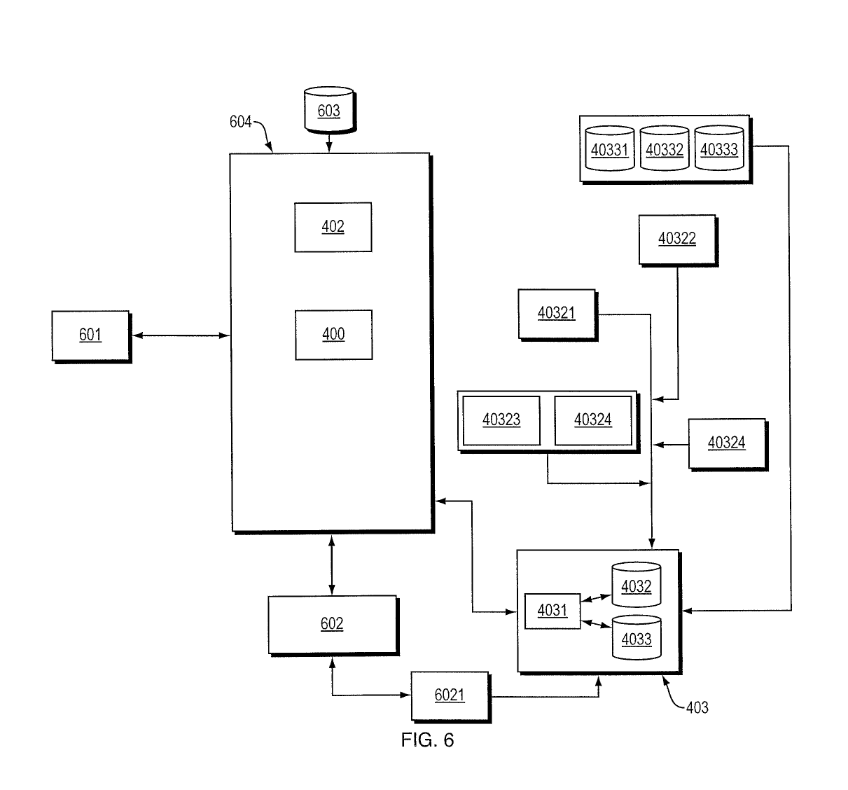

FIG. 6 illustrates an exemplary context in which the systems and methods described herein can be employed. In particular, FIG. 6 provides an example in the context of utilization management pre-authorization. A stakeholder 601, such as a physician, submits a pre-authorization request for performing “Vertebroplasty/Kyphoplasty” of a bone in the low back. The physician attaches documentation about the diagnosis and justification for the procedure. This external stakeholder request initiates the utilization management pre-authorization decision making process. Stakeholder 601 may submit his preauthorization request in a variety of different ways. The request may be made by telephone, via facsimile, via email or over the Internet. In the Internet embodiment, the organization computer system 604 may host a web application, allowing stakeholders to transmit and receive information to and from organization computer system 604.

The decision query enrichment component 402 (one or a series of software modules) creates a synthesis of the physician's request. In this example, decision query enrichment component 402 identifies the right set of procedure codes for Vertebroplasty/Kyphoplasty from the organization's procedure code database 603. It also summarizes the risks involved in approving the submitted request (i.e., to mitigate medical and financial risks). The decision query enrichment component 402 identifies two risks associated with this procedure:

Risk #1 identified—The procedure may be considered investigational in some situations.

Risk #2 identified—This procedure has associated/applicable clinical guidelines and medical policies; need to validate the request relative to the guidelines and policies.

A decision query is associated with each identified risk:

Decision query #1—What are the characteristics associated with this procedure that define a specific situation as investigational?

Decision query #2—What guidelines and policies are applicable to this request and does this request comply with the guidelines and policies?

Next, data related to exceptional attributes is extracted from the information submitted by the physician. Exceptional attributes are based on the identified risks. The following exceptional attributes are extracted in this example:

Exceptional Attribute #1: Extract data of any other pain medicines or physical therapy and associated results.

Exceptional Attribute #2: Extract data of any medical studies to support or justify the request.

The synthesis assessment algorithm 501 in the bootstrapping engine component 400 (one or a series of software modules) then assesses the synthesis. In particular, for each risk, a risk level is set and a minimum confidence level threshold for approval is assigned.

Confidence level threshold for mitigating Risk #1 must be—100% (The procedure must not be investigational). Risk level is set to High.

Confidence level threshold for mitigating Risk #2 must be—100% (The procedure must comply with all applicable clinical guidelines and medical policies). Risk level is set to High.

The machine learning component 403 (one or a series of software modules) responds to each decision query with a recommendation and associated confidence level based on the evidence data 4032 used. Machine learning component 403 includes decision making software 4031 which relies on evidence data in database 4032 and training data in database 4033 in order to process inputs and generate outputs. In one exemplary embodiment, machine learning component 403 comprises a computerized system or part of a computerized system that is capable of forming, persisting, recalling, and using knowledge to render a final decision or a decision recommendation. Examples of machine learning components include artificial intelligence systems and logic driven expert systems. As described herein, machine learning is extended by introducing the notion of evidence. Evidence confirms knowledge by sharing experiences between machine learning components and (human) knowledge workers. Both machine learning components and human knowledge workers share experience in the form of evidence and associate applicable evidence to final decisions or decision recommendations.

In one exemplary embodiment, training data 4033 includes health data of the individual from database 40331, clinical history data of the individual from database 40332, and claims history information of the individual from database 40333. Referring further to an exemplary embodiment, evidence data 4032 includes quality of care guidelines 40321, outcome research data 40322, medical guidelines 40323 and clinical guidelines 40324 of the organization, and medical literature information 40324. Continuing with the example:

Decision query #1 recommendation:
The request cannot be approved as there is no documentation of other therapies (activity changes, pain medication, physical therapy) having been tried and not worked.
Confidence level on this recommendation=100%
Evidence source=Healthplan medical policy percutaneous vertebroplasty and percutaneous kyphoplasty, SURG.00067

Decision query #2 recommendation:
The request does not comply with organization's medical policies.
Confidence level on this recommendation=100%
Evidence source=Healthplan medical policy percutaneous vertebroplasty and percutaneous kyphoplasty, SURG.00067

The confidence level assessment algorithm 502 in the bootstrapping engine component 400 extracts the risk level and confidence level from the request synthesis and also extracts the confidence level from the machine learning decision recommendation. Continuing with the example:

Based on High Risk: High Confidence Level ratio, this request is bootstrapped to the risk inclined decision path for further mitigation in the form of payer decision.

The decision path bootstrapping algorithm 503 of the bootstrapping engine component 400 selects specific next steps for knowledge worker 602 to form a decision on the pre-authorization request from the stakeholder 601.

Decision Path Step 1: Decide if request is to be denied or request more information from physician.

Decision Path Step 2: If the decision is to deny the request, escalate the final decision to the MD.

Knowledge worker 602 then proceeds to follow the steps of the decision path.

Decisions and notes from knowledge worker 602 may be stored in a database 6021 and fed back into machine learning component 403 to be used as training data 4033, in one embodiment. Knowledge worker 602 may also access the computer systems of the organization 604 using the Internet using a web application hosted by the organization.

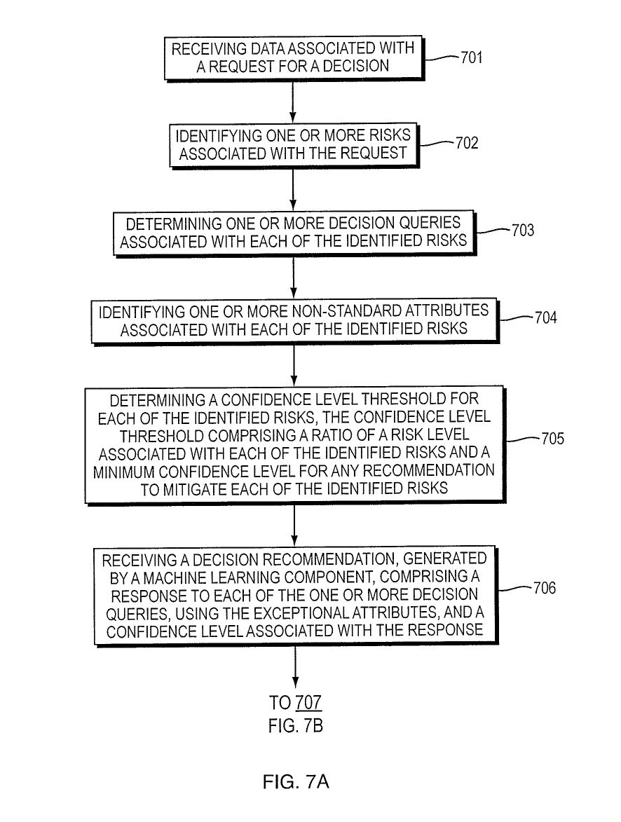

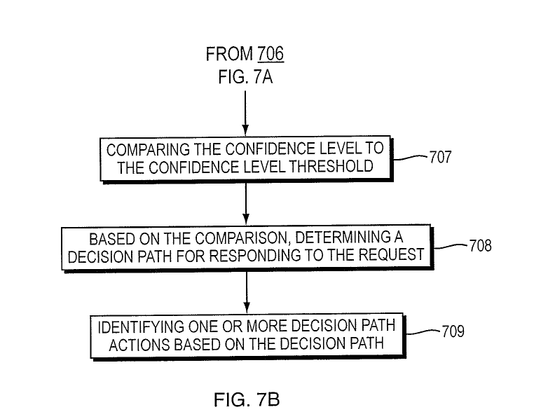

An exemplary method of one embodiment of the present invention is described with reference to FIGS. 7A and 7B. In step 701, data associated with a request for a decision is received.

In step 702, one or more risks associated with the request are identified. Risks are associated with the decision goals implied in the decision request. For example, a pre-authorization approval request has an implied decision goal of approving the medical procedures included in the pre-authorization request. A decision on the request has positive or negative impacts on involved and/or affected stakeholders (e.g., providers, members, payers). The process of identifying decision risks may include the use of different sources of risk factors. In one exemplary embodiment, such sources include the following:
Policies: Policy compliance is a risk factor in all decisions. Non-compliance with guidelines and best practices increases the risk of any decisions.
Stakeholder abrasion: Stakeholder abrasion is also a risk factor in most, if not all, decisions. For example, denying a pre-authorization request increases the risk of member and/or provider abrasion.
Fraud and Abuse: Fraud and abuse is a major risk factor in assessing pre-authorization requests. Historical references as well as previous incidents of fraud associated with specific types of medical procedures or providers or members are included in the risk assessment of each decision.
Financial Concerns: Financial constrains is another important risk factor. For example, a member's current benefits coverage determines the distribution of financial liabilities across providers, members, and payers. Hence, before a decision is rendered, the necessary financial impacts and implications need to be mitigated.

In this example, mitigating the above referenced risk factors is an important part of the decision rendering process. If all risk factors are mitigated, the confidence level in rendering the implied decision (e.g., approval) is high (close to 100%). If none of the risk factors are mitigated, the confidence level in rendering the implied decision is very low, but the confidence level of rendering the complement of the implied decision (e.g., denial) is high (close to 100%).

In step 703, one or more decision queries associated with each of the identified risks are determined. A decision query differs from an ordinary information query in terms of the results of the query. A decision query results in a recommended or rendered decision. An information query results in finding relevant information. Each decision query results in a recommended or rendered decision supported by evidence (e.g., information) and a confidence level. Decision queries are determined based on the identified risk factors and the implied decision associated with each request. If the confidence level associated with the implied decision is low, (e.g., <50 percent), then additional decision queries may also be determined to mitigate risk factors associated with the complement of the implied decision. For example, assume one decision query for each of the four risk factors mentioned above has been determined and that mitigation of 50 percent of the risks is outstanding. In this example, additional decision queries may also be determined to assess if the request should be denied (i.e., the complement of approved).

In step 704, any non-standard attributes associated with each of the identified risks are identified. Non-standard attributes are indicators of exceptional events and states. For example, an emergency surgery request has an implied exception where some additional or different rules may apply. A pre-authorization request in the context of medical emergency has non-standard attributes and a different set of rules can apply to the decision making process. In one exemplary embodiment, non-standard attributes are pre-determined (e.g., selected) and can change over time.

In step 705, a confidence level threshold for each of the identified risks is determined. The confidence level threshold is a ratio of a risk level associated with each of the identified risks and a minimum confidence level for any recommendation to mitigate each of the identified risks. Leveling of risks is a process of categorizing risks based on type of risk mitigation. There are three levels of risks that affect the rendering or recommendation of decisions, in one exemplary embodiment:

Level 1: Mandatory mitigation—Risks at this level must be mitigated before a decision is rendered.

Level 2: Best Practice mitigation—Risks at this level must be mitigated before a decision is rendered or recommended.

Level 3: Optional/Discretionary mitigation—Risks at this level may be mitigated before a decision is rendered or recommended.

The difference between rendering and recommending decisions is that rendered decisions are final whereas decision makers and other decision-making processes can override recommended decisions. There are additional rules for rendering or recommending a specific decision. In order to render a decision, the confidence level of mitigating all relevant levels of risk must be 100 percent. If the confidence level is <100 percent, then a decision recommendation is possible instead of a rendering a final decision.

In step 706, a decision recommendation, generated by a machine learning component, is received. The decision recommendation comprises a response to each of the one or more decision queries, determined based on the exceptional attributes, if any, and a confidence level associated with the response. Exceptional or non-standard attributes trigger a different set of rules (e.g., weighting of risk levels) in the decision-making process and, specifically, in compiling responses to decision queries. A decision query responds with a rendered decision or a recommended decision. Exceptional attributes (e.g., emergency surgery) can change the weightage assigned to risk levels and associated risk factors mitigated as part of processing the decision query. For example:

| | Normal attributes | Exceptional attributes |
|---|---|---|
| Risk level 1: Mandatory | X | X |
| mitigation | | |
| Risk level 2: Best practice | X | Y |
| mitigation | | |
| Risk level 3: Optional or | Y | Y |
| Discretionary mitigation | | |

Rendering a decision requires mitigation of all risk levels with weightage “X”. When exceptional attributes (such as emergency surgery) exist, fewer risk levels have weightage “X”. If mitigation of risk levels with weightage “Y” is possible, then a recommended decision is in the response to decision queries.

In step 707, the confidence level is compared to the confidence level threshold. In step 708, based on the comparison, a decision path for responding to the request is determined.

In step 709, one or more decision path actions are determined based on the decision path. In the exemplary embodiment, actions are predetermined and associated with a specific decision path (for example, an “Approval” decision path or a “Denial” decision path). Actions include review of rendered decision, review and follow up on recommended decision or overriding recommended decision. Specific actions are associated to decisions path to facilitate achieving the goals of the decisions path. For example, in the “Approval” decision path, if an approval decision is rendered, then a simple review of the rendered decision is the only action needed. If, however, in the “Approval” decision path, an approval decision recommendation is made, then a review and follow up on recommended approval decision is needed. If the confidence level associated with a recommended approval decision is low (e.g., <50 percent), then a likely override of approval recommendation into a “denial” decision is possible.

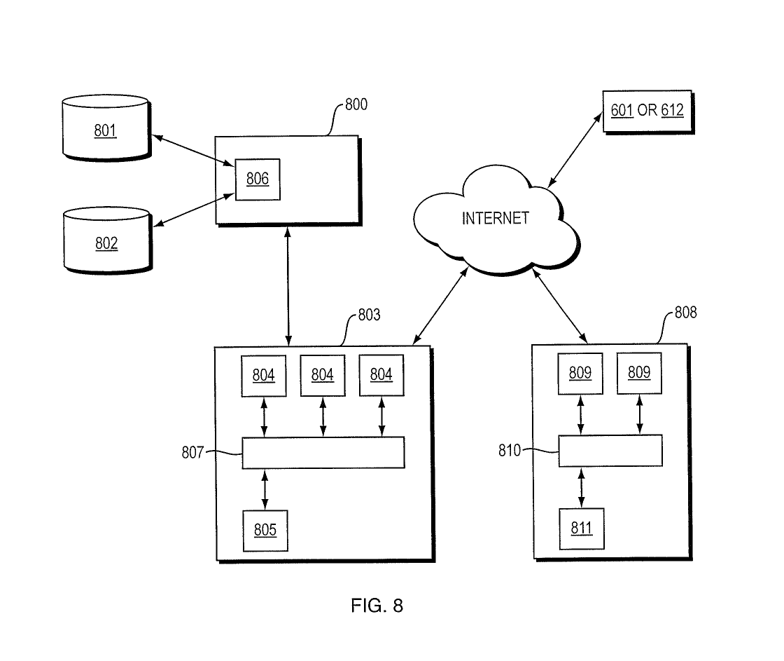

Exemplary hardware and software employed by the systems discussed herein are now generally described with reference to FIG. 8. Database server(s) 800 may include a database services management application 806 that manages storage and retrieval of data from the database(s) 801, 802. The databases may be relational databases; however, other data organizational structure may be used without departing from the scope of the present invention. One or more application server(s) 803 are in communication with the database server 800. The application server 803 communicates requests for data to the database server 800. The database server 800 retrieves the requested data. The application server 803 may also send data to the database server for storage in the database(s) 801, 802. The application server 803 comprises one or more processors 804, computer readable storage media 805 that store programs (computer readable instructions) for execution by the processor(s), and an interface 807 between the processor(s) 804 and computer readable storage media 805. The application server may store the computer programs referred to herein.

To the extent data and information is communicated over the Internet, one or more Internet servers 808 may be employed. The Internet server 808 also comprises one or more processors 809, computer readable storage media 811 that store programs (computer readable instructions) for execution by the processor(s) 809, and an interface 810 between the processor(s) 809 and computer readable storage media 811. The Internet server 808 is employed to deliver content that can be accessed through the communications network, e.g., by stakeholder 601 or knowledge worker 602. When data is requested through an application, such as an Internet browser, the Internet server 808 receives and processes the request. The Internet server 808 sends the data or application requested along with user interface instructions for displaying a user interface.

The computers referenced herein are specially programmed, in accordance with the described algorithms, to perform the functionality described herein. The software modules described herein are, in one embodiment, executed on the systems of the organization 604, of FIG. 6. However, other parties may perform portions of the services and calculations described herein within the scope of the present invention.

The non-transitory computer readable storage media that store the programs (i.e., software modules comprising computer readable instructions) may include volatile and non-volatile, removable and non-removable media implemented in any method or technology for storage of information such as computer-readable instructions, data structures, program modules, or other data. Computer readable storage media may include, but is not limited to, RAM, ROM, Erasable Programmable ROM (EPROM), Electrically Erasable Programmable ROM (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computer system and processed.

What is claimed is:

1. A computer implemented method comprising:
receiving data associated with a request for a decision;
identifying one or more risks associated with the request;
determining one or more decision queries associated with each of the identified risks;
identifying any non-standard attributes associated with each of the identified risks;
determining a confidence level threshold for each of the identified risks, the confidence level threshold comprising a ratio of a risk level associated with each of the identified risks and a minimum confidence level for any recommendation to mitigate each of the identified risks;
receiving a decision recommendation, generated by a machine learning component, comprising a response to each of the one or more decision queries, determined based on the exceptional attributes, if any, and a confidence level associated with the response;
comparing the confidence level to the confidence level threshold;
based on the comparison, determining a decision path for responding to the request; and
identifying one or more decision path actions based on the decision path.

2. A non-transitory computer-readable storage medium that stores instructions which, when executed by one or more processors, cause the one or more processors to perform a method comprising:
receiving data associated with a request for a decision;
identifying one or more risks associated with the request;
determining one or more decision queries associated with each of the identified risks;
identifying any non-standard attributes associated with each of the identified risks;
determining a confidence level threshold for each of the identified risks, the confidence level threshold comprising a ratio of a risk level associated with each of the identified risks and a minimum confidence level for any recommendation to mitigate each of the identified risks;
receiving a decision recommendation, generated by a machine learning component, comprising a response to each of the one or more decision queries, determined based on the exceptional attributes, if any, and a confidence level associated with the response;
comparing the confidence level to the confidence level threshold;
based on the comparison, determining a decision path for responding to the request; and
identifying one or more decision path actions based on the decision path.

3. A system comprising:
memory operable to store at least one program; and
at least one processor communicatively coupled to the memory, in which the at least one program, when executed by the at least one processor, causes the at least one processor to:
receive data associated with a request for a decision;
identify one or more risks associated with the request;
determine one or more decision queries associated with each of the identified risks;
identify any non-standard attributes associated with each of the identified risks;
determine a confidence level threshold for each of the identified risks, the confidence level threshold comprising a ratio of a risk level associated with each of the identified risks and a minimum confidence level for any recommendation to mitigate each of the identified risks;
receive a decision recommendation, generated by a machine learning component, comprising a response to each of the one or more decision queries, determined based on the exceptional attributes, if any, and a confidence level associated with the response;
compare the confidence level to the confidence level threshold;
based on the comparison, determine a decision path for responding to the request; and
identify one or more decision path actions based on the decision path.
